(19) United States
(12) Patent Application Publication
(10) Pub. No.: US 2014/0337961 A1
(43) Pub. Date: Nov. 13, 2014

(54) SYSTEM FOR IMPLEMENTING DYNAMIC ACCESS TO PRIVATE CLOUD ENVIRONMENT VIA PUBLIC NETWORK

(71) Applicant: PROMISE TECHNOLOGY, INC., Hsin-Chu (TW)

(72) Inventors: Hung-Ming Hammer Chien, Hsin-Chu (TW); Teng-Yu Denny Tsai, Kaohsiung (TW)

(73) Assignee: PROMISE TECHNOLOGY, INC., Hsin-Chu (TW)

(21) Appl. No.: 13/889,363

(22) Filed: May 8, 2013

(51) Int. Cl. H04L 29/06

(52) U.S. Cl. CPC H04L 63/10; H04L 63/08
USPC 726/12

(57) ABSTRACT

A system for implementing dynamic access to a private cloud environment via a public network is provided. The private cloud environment includes a gateway device linking to the public network and a plurality of storage devices connected to the gateway device. The system includes an intermediary server and a user terminal. The user terminal is linked to the intermediary server, via the public network, for acquiring a public IP address associated with the gateway device and a port information associated with the storage devices after being authenticated by the intermediary server. Then, the user terminal is linked to the gateway device in accordance with the public IP address, and is connected to the storage devices in accordance with the port information to access data from the storage devices.

### CROSS-REFERENCE TO RELATED APPLICATION

This utility application claims priority to Taiwan application serial number 102109952, filed on Mar. 21, 2013, that is incorporated herein by reference.

### BACKGROUND OF THE DISCLOSURE

1. Field of the Disclosure

The invention relates to a system for accessing a private cloud environment, and particularly, a system for accessing a private cloud environment via public network without knowledge of the IP address of gateway device and the virtual IP address of storage device attached behind the gateway device.

2. Brief Description of the Related Art

With advent of cloud computing, some service providers has provided services of public cloud computing and storage. For instance, AWS (Amazon Web Service) of Amazon Co., Cloud Computing and Hard Disk Service of Dropbox or MegaUpload Co.

However, data security issue due to hackers and disk crash are still important concerns when considering use of the public cloud computing and storage. This concern has been a main obstacle for the wide acceptance by most enterprises.

The users typically employ RAID storage system or JBOD (Just a Bunch of Disks) storage system within Intranet system to build DAS (Direct Attached Storage), NAS (Network Attached Storage), SAN (Storage Attachment Network) or SAN/NAS storage architecture. Nevertheless, the storage device system of this type within Intranet system needs to be assigned a virtual IP address. Consequently, as users intend to access data remotely of storage device within its Intranet system, they have to know the IP address of gateway device and the virtual IP address of storage device attached behind the gateway device. Furthermore, in practical, the virtual IP address is varied frequently due to security reasons. It is clear that the state of arts does not provide a convenient way for the users to remotely access data of storage device within their Intranet system.

Hence, the invention intends to provide a system which, via public network, could dynamically access data within a private cloud environment without knowledge of the IP address of gateway device and the virtual IP address of storage device attached behind the gateway device.

### SUMMARY OF THE DISCLOSURE

According to a preferred embodiment, the system includes an intermediary server and a user terminal allowing the user terminal, via public network, to access data of a private cloud environment. The private cloud environment includes gateway device connected to the public network and multiple storage devices coupled to the gateway device. The intermediary server, via the public network, is connected to the gateway device. The gateway device is designed and programmed to store port information of multiple storage devices. The private cloud environment has the capabilities of updating and transmitting the updated public IP address of gateway device and port information of multiple storage devices to the intermediary server. The user terminal is, via the public network, coupled to the intermediary server. The intermediary server is programmed for authenticating the user terminal to allow the users to retrieve the public address of gateway device and the port information of multiple storage devices. After being authenticated, the user terminal, based on the public address given, connects to the gateway device successfully and, based on the port information retrieved, proceeds data access to the multiple storage devices. By this way, the objective of the invention is accomplished. The users needs only the authentication information and hence effort of memorizing of public address and virtual IP address is no longer required.

The event information of multiple storage devices, among others, includes re-direct information of specified files on the multiple storage devices. The private cloud environment is programmed to update the event information and transmit the same to the intermediary server. The user terminal, based on the updated event information on the intermediary server, performs the data access to the multiple storage devices.

Optionally, a public cloud storage device is provided to connect to the public network for storing a duplicate copy of specified files within storage multiple storage devices of private cloud system. This approach can be used for data of low security level. As the user terminal access the specified files, based on re-direct information on the intermediary server, the user terminal is coupled to the public cloud storage device to access the specified files. By the approach, transmission bandwidth needed for the system while a lot of users access data of high security level in the multiple storage devices of private cloud system can be relieved.

The accompanying drawings, incorporated as a part of this specification, are used for further understandings of the preferred embodiments of the invention and can not be used to limit the protected scope of the invention that are described in the attached claims.

### BRIEF DESCRIPTION OF THE DRAWINGS

FIG. 1 illustrates the system of the instant invention.

While preferred embodiments are depicted in the drawings, those embodiments are illustrative and are not exhaustive, and many other equivalent embodiments may be envisioned and practiced based on the present disclosure by persons skilled in the arts.

### DETAILED DESCRIPTION OF THE INVENTION

The present invention now will be described more fully herein with reference to the accompanied figures, in which embodiments of the invention are shown. This invention may, however, be embodied in many alternate forms and should not be construed as limited to the embodiments set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like numbers refer to like elements throughout the description of the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising” used in this specification do not preclude the presence or addition of one or more other selectivity features, steps, operations, elements, components, and/or groups thereof. And the term “and/or” includes any and all combinations of one or more of the associated listed items.

Unless otherwise defined, all terms used herein have the same meaning as commonly understood by one of ordinary skill in the art to which this invention belongs. It will be further understood that terms defined in commonly used dictionaries will not be interpreted in an idealized or overly formal sense unless expressly so defined herein.

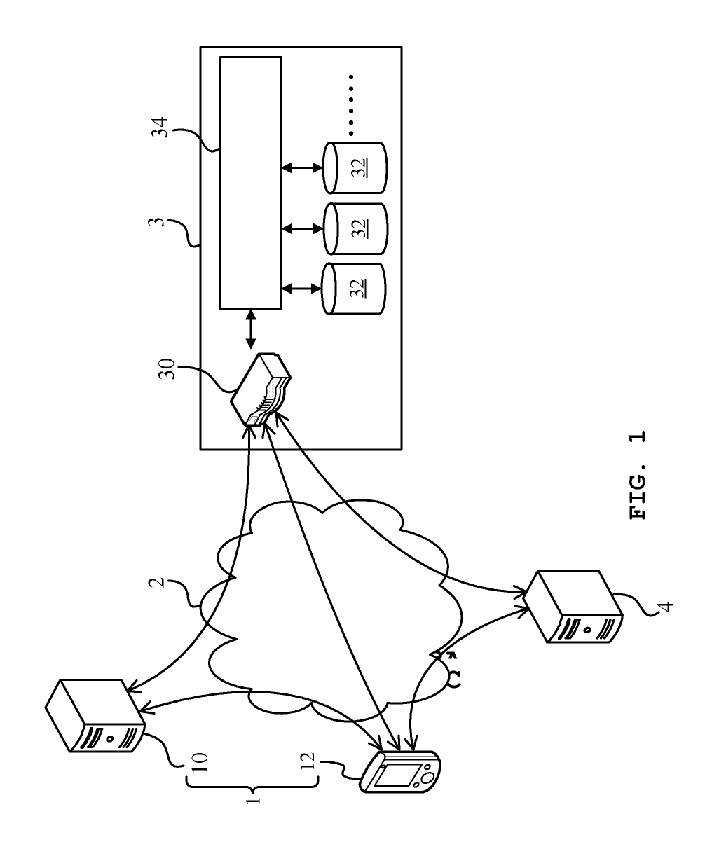

Referring to FIG. 1, a preferred embodiment of the system 1 of the instant invention is disclosed for, via public network 2, accessing dynamically a private cloud environment 3 without users knowledge of the IP address of gateway device and the virtual IP address of storage device attached behind the gateway device.

The private cloud environment 3 includes a gateway device 30 connected to a public network 2 and multiple storage devices 32 are connected to the gateway device 30 via a storage controller 34 which is coupled to the gateway device 30 and the multiple storage device 32 respectively for controlling the data access of multiple storage devices 32.

The public network 2 might be Internet, Extranet, LAN (local area network), WAN (wide area network), Ethernet, cable TV network, radio telecommunication network, public switched telephone network, 3G network, HSPA network, Wi-Fi network, WiMAX network, LTE network, or other public networks.

As shown, the system 1 includes an intermediary server 10 and a user terminal 12. The user terminal 1 might be any kinds of data processing devices, such as smart phones and tablet computing devices. The intermediary server 10 is connected to the gateway device 30 via the public network 2.

The gateway device 30 is designed and programmed to store port information of multiple storage devices 32. The private cloud environment 3 has the capabilities of updating and transmitting the updated public IP address of gateway device 30 and port information of multiple storage devices 32 to the intermediary server 10. The user terminal 12 is, via the public network 2, coupled to the intermediary server 10. As to the port information of multiple storage devices 32, they might be UPnP port address mapping information, DMZ port address mapping information or dynamic DNS information.

The intermediary server 10 is programmed for authenticating the user terminal 12 to allow the users to retrieve the public address of gateway device 30 and the port information of multiple storage devices 32. After being authenticated by the intermediary server 10, the user terminal 12, based on the public address obtained, connects to the gateway device 30 successfully and, based on the port information obtained, proceeds data access to the multiple storage devices 32. The users needs only the authentication information required by the intermediary server 10 and efforts of memorizing of public address and virtual IP address are no longer required.

The intermediary server 10 can be programmed to manage multiple of the private cloud environments 3. Each private cloud environment 3 is assigned an identification name and a set of passwords. The users, via the user terminal 12, log on the intermediary server 10 and search for the ID of private cloud he intends to access. The intermediary server 10 then provides one corresponding private cloud environment 3 responsive to the search. The users then enter his/her password in order to access the target private cloud environment 3. The authentication is confirmed as the password has been checked as valid.

As the user terminal 12 is allowed to couple to multiple storage devices 32 by the intermediary server 10, the accessed data could be first encrypted by SSL protocol and then transmitted point-to-point between the user terminal 12 and gateway device 30.

The event information of multiple storage devices 32, among others, includes re-direct information of specified files on the multiple storage devices 32. The private cloud environment 3 is programmed to update the event information and transmit the same to the intermediary server 10. The user terminal 12, based on the updated event information on the intermediary server 10, performs the data access to the multiple storage devices 32.

In addition and optionally, a public cloud storage device 4 is provided to connect to the public network 2 for storing a duplicate copy of specified files within storage multiple storage devices 32. This approach can be used for data of low security level. As the user terminal 12 access the specified files, based on re-direct information on the intermediary server 10, the user terminal 12 is coupled to the public cloud storage device 4 to access the specified files. By this approach, transmission bandwidth needed for the system 1 while a lot of users access data of high security level in the multiple storage devices 32 can be relieved.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain. Furthermore, unless stated otherwise, the numerical ranges provided are intended to be inclusive of the stated lower and upper values. Moreover, unless stated otherwise, all material selections and numerical values are representative of preferred embodiments and other ranges and/or materials may be used.

The scope of protection is limited solely by the claims, and such scope is intended and should be interpreted to be as broad as is consistent with the ordinary meaning of the language that is used in the claims when interpreted in light of this specification and the prosecution history that follows, and to encompass all structural and functional equivalents thereof.

What is claimed is:

1. A system for dynamically accessing a private cloud environment via a public network, the private cloud environment including a gateway device connected to the public network and multiple storage devices connected to the gateway device, the system comprising:
an intermediary server, via the public network, connected to the gateway device, for receiving a public address, from the private cloud environment, with respect to the gateway device and a port information with respect to the multiple storage devices; and
a user terminal, connected to and authenticated by the intermediary server via the public network, for retrieving the public address with respect to the gateway device and the port information with respect to the multiple storage devices, and then based on the public address for connecting the gateway device, and based on the port information for connecting the multiple storage device in order to perform data access to the private cloud environment.

2. The system of claim 1, wherein the port information is an UPnP port address mapping information, a DMZ port address mapping information or a dynamic DNS information.

3. The system of claim 1, wherein as the user terminal accesses data of the multiple storage devices, the accessed data, after being encrypted using SSL protocol, are transmitted point-to-point between the user terminal and the gateway device.

4. The system of claim 1, wherein the multiple storage devices are connected to the gateway device via an Intranet.

5. The system of claim 1, wherein the private cloud environment updates and transmits an event information with respect to the multiple storage devices, the user terminal proceeds data access based on the event information.

6. The system of claim 5, wherein a public cloud storage device is connected to the public network, a specified file of the multiple storage device is replicated in the public cloud storage device, the event information includes a re-direct information with respect to the specified file, and as the user terminal intends to access the specified files, the user terminal is directed to access the specified file based on the re-direct information by connecting to the public cloud storage device.

7. The system of claim 1, wherein the public network is selected from a group comprising of Internet, Extranet, LAN, WAN, Ethernet, Cable TV network, radio telecommunication network, public switched telephone network, 3G network, HSPA network, Wi-Fi network, WiMAX network and LTE network.
